(19) United States
(12) Patent Application Publication
(10) Pub. No.: US 2007/0295558 A1
(43) Pub. Date: Dec. 27, 2007

(54) DEVICE FOR LUBRICATING CONTRA-SLIDING PARTS

(75) Inventors: Ralf Lottgen, Biel (CH); Michael Hauser, Biel (CH); Jens Thing, Ipsach (CH)

Correspondence Address: BACHMAN & LAPOINTE, P.C., 900 CHAPEL STREET, SUITE 1201, NEW HAVEN, CT, 06510, US

(73) Assignee: MIKRON AGIE CHARMILLES AG, Nidau (CH)

(21) Appl. No.: 11/743,731

(22) Filed: May 3, 2007

(30) Foreign Application Priority Data
May 16, 2006 (EP) 06 010 031.0

(51) Int. Cl. F16C 1/24; F16N 3/00

(52) U.S. Cl. 184/14; 184/5.1

(57) ABSTRACT

A device for lubricating contra-sliding parts of a tool device having a drive for effecting the sliding operation, wherein the device has a lubricant dispensing device for the moving parts, which lubricant dispensing device can be actuated by means of the same drive. A method for lubricating contra-sliding parts of a tool device having a drive for effecting the sliding operation, wherein a lubricating pulse is triggered by the following method steps: measuring of the path covered in the operating phase of the sliding parts, recording of the individual path lengths by means of a counter, comparison of the total actual path length with a total path length after which a lubricating pulse is intended to be triggered, and triggering of a lubricating pulse by the same drive for the sliding parts after the cumulative total path length has been reached.

### BACKGROUND OF THE INVENTION

The invention relates to a device for lubricating contra-sliding and rolling parts of a tool device having a drive for effecting the sliding operation or rolling operation.

The invention further relates to a method for lubricating contra-sliding parts of a tool device having a drive for effecting the sliding operation or rolling operation.

Manual lubricating systems for tool devices are previously known. Once a specific machine operating time has been reached, the user must lubricate the machine at specific places. Alternatively, separate lubricating systems with dedicated drive are used. The invention can be used for all machines and machine parts in which sliding or rolling parts must be lubricated. This also applies to machines with linear motor.

The object of the present invention is to propose a lubricating system for a tool device, which system automatically, after certain machine operating time intervals, supplies the lubrication points with a lubricant in the quantity required.

### SUMMARY OF THE INVENTION

The object is achieved according to the invention by fact that the device has a lubricating device for the moving parts, which lubricating device can be actuated by means of the same drive.

In addition, the object is achieved according to the invention by the following method steps: measuring of the path covered in the operating phase of the sliding parts, recording of the individual path lengths by means of a counter, comparison of the total actual path length with a total path length after which a lubricating pulse is intended to be triggered, and triggering of a lubricating pulse by the same drive for the sliding parts after the cumulative total path length has been reached.

Further embodiments of the device according to the invention for lubricating contra-sliding parts emerge from sub-claims 2 to 11 and from the description of the figures.

The invention can be used in all machine tools having moving parts to be lubricated, in particular for the x, y and z-axis guides in milling machines, electroerosion machines, etc. A central lubrication can here be realized simultaneously for all axes, triggered by, for example, the x-axis guide. However, a lubricating system can also respectively be provided separately for each axis.

The advantages obtained with the invention reside particularly in the fact that it is possible to dispense with an additional drive for lubrication purposes. In addition, the invention offers a higher operating reliability compared to a manual lubrication.

### BRIEF DESCRIPTION OF THE DRAWINGS

The invention is described below with reference to an illustrative embodiment, wherein:

FIG. 1 shows a spindle-slide arrangement having a lubricating device,

FIG. 2 shows a sectional drawing of a lubricating device,

FIG. 3 shows a sectional drawing of a spindle-slide arrangement with lubricating device,

FIG. 4 shows a further sectional drawing of a spindle-slide arrangement with lubricating device,

FIG. 5 shows a block diagram showing the process of the lubricating operation.

### DETAILED DESCRIPTION

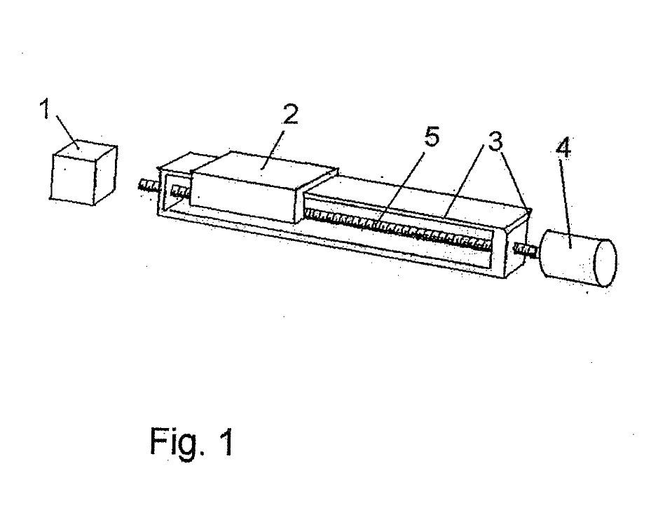

FIG. 1 shows in diagrammatic representation a spindle-slide device having a lubricant dispensing device 1. The slide 2, which is displaceable in guides 3 and is connected to a spindle 5, is longitudinally displaceable by means of the drive 4. Disposed diagrammatically behind the spindle-slide device is a lubricant dispensing device 1, which, by means of the drive 4, triggers lubricating pulses. The lubricant dispensing device i.e., lubricating device can be of hydraulic, pneumatic, directly or indirectly mechanical, electromechanical or similar configuration. An indirectly mechanical, sawtooth-shaped embodiment is described by way of example below.

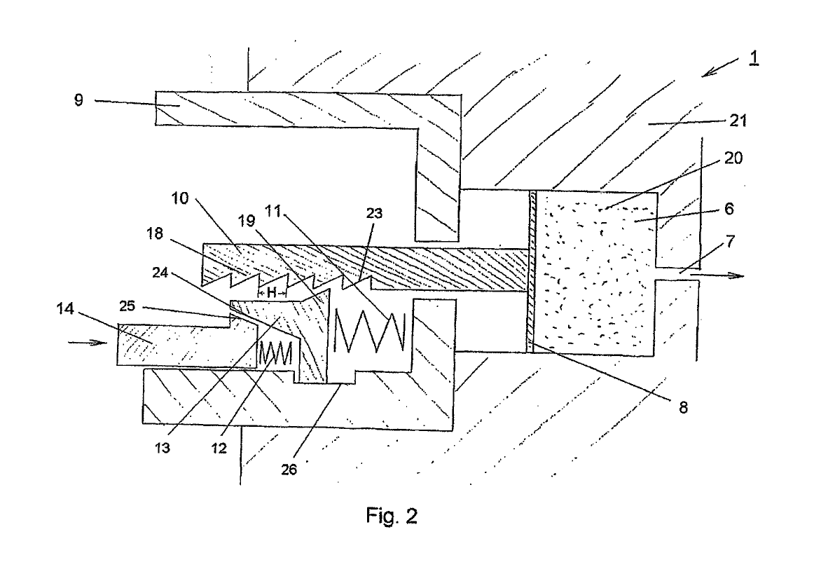

The exemplary mechanism for triggering the lubricating pulses is shown in FIG. 2. The lubricating device 1 has a housing 9, which is disposed in a further housing 21. The lubricant 20 is stored in a reservoir 6. In the reservoir 6 there is a piston 8, which, when actuated, conveys the lubricant in the direction of an outlet 7. The outlet 7 is connected, for example, to a distributor (not represented), which feeds the lubricant 20 to the individual lubrication points via lines (likewise not represented). The piston 8 is connected to a piston rod 10. The piston rod 10 has a sawtooth-shaped region 18 having a plurality of teeth 23. Engaging in the teeth 23 of the sawtooth-shaped region 18 is an actuating part 13. Attached to the actuating part 13 is a projection 19, which matches the shape of the teeth 23 of the sawtooth-shaped region 18. The actuating part 13 is mounted displaceably on the inner lower face 26 of the housing 9. By means of a thrust part 14, the actuating part 13 is pushed upwards and forwards—guided by the oblique face 24 of the actuating part 13 and the oblique face 25 of the thrust part 14—, whereupon the projection 19 of the actuating part 13 engages in a tooth 23 of the piston rod 10 and the latter pushes the piston 8 forwards to execute a lubricating pulse. Between the housing 9 and the actuating part 13 and between the actuating part 13 and the thrust part 14, a spring 11 and 12 is respectively provided for the rearward movement of the actuating part 13 and thrust part 14 following execution of a stroke. The stroke length H of the piston 8 corresponds to a tooth length of a tooth 23.

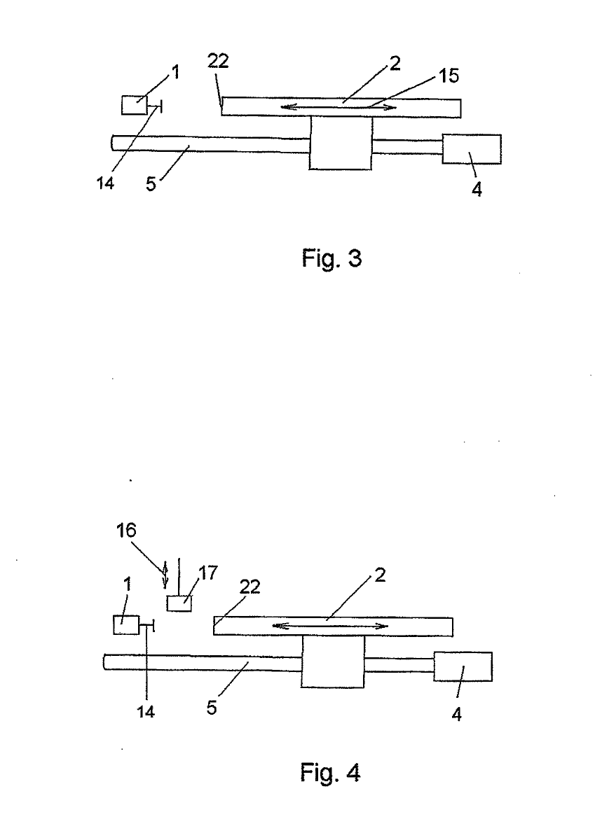

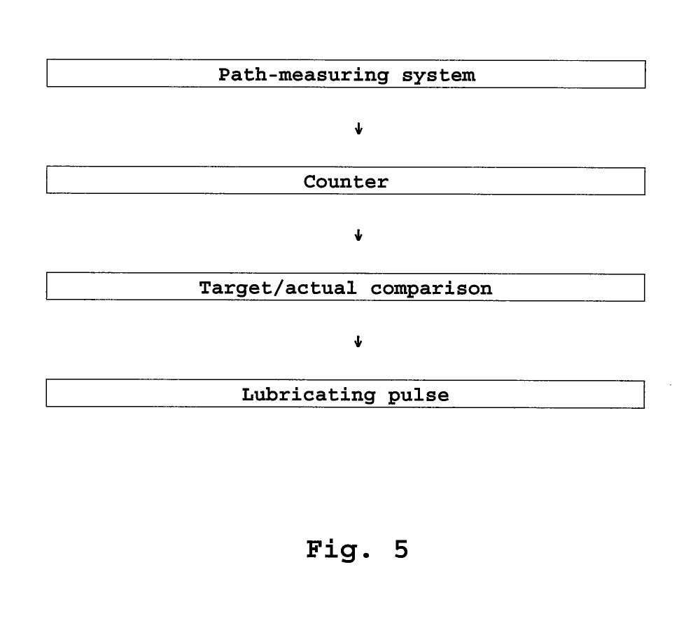

In FIGS. 3 and 4, two examples of the triggering mechanism of a lubricating pulse are shown in simplified representation. In both FIGS. 3 and 4, the slide 2 can be seen. The slide 2 is connected to the spindle 5, which, through the drive 4, displaces the slide forwards and rearwards according to the double arrow 15.

In FIG. 3, a lubricating pulse is triggered by contact of the end face 22 of the slide 2 with the thrust part 14 of the lubricating device 1.

In FIG. 4, a slide bar 17 is provided, which can be transported between the lubricating device 1 and the end face 22 of the slide 2 according to the double arrow 16. The slide bar 17 can trigger the lubricating pulse, on the one hand, by movement in the direction of the thrust part 14 or, on the other hand, by contact with the end face 22 of the slide 2.

The block diagram in FIG. 5 describes the process for generating a lubricating pulse. The point at which a lubricating pulse is to be triggered is reached after a specific operating period of the parts to be lubricated. The length of time is obtained, for example, by measuring the individual path lengths covered by the slide 2 by means of a path-measuring system. The path lengths are recorded via a counter. The actual number of path lengths are compared with a total number chosen within the system. As soon as, in a target-actual comparison, the total number is reached, a lubricating pulse is triggered and the counter is reset to zero. The cycle begins afresh. The criteria for a lubricating pulse can be realized individually or in combination according to use, based on the following criteria.

The lubrication is realized, for example

after a specific number, for example, of strokes of the slide 2. Neither the length nor the direction of the strokes plays a role in this. A stroke is defined as a movement out of the rest position of the slide 2;

after a specific total path, to be defined;

after a specific operating time of the tool device, to be defined.

The invention is applicable to all conceivable machine tools in multi-axis operation, such as, for example, milling machines, electroerosion machines, lathes, grinding machines, etc.

1. A tool device comprising contra-sliding and rolling parts and a drive for effecting sliding operation of the contra-sliding and rolling parts, a device for lubricating the contra-sliding and rolling parts comprises a lubricant dispending device wherein the lubricant dispensing device is activated by the drive for the tool device.

2. A tool device according to claim 1, wherein the lubricant dispensing device has a reservoir disposed in a housing, for the lubricant being dispensed.

3. A tool device according to claim 2, wherein the reservoir includes at least one outlet for the lubricant and at the outlet there is provided a distributor with lines leading to lubrication points.

4. A tool device according to claim 1, wherein the lubricant dispensing device is activated by at least one of directly mechanical, indirectly mechanical, hydraulic, pneumatic and electromagnetic means.

5. A tool device according to claim 3, wherein the reservoir has a piston having a piston rod for conveying the lubricant into the distributor.

6. A tool device according to claim 5, wherein the piston rod has a sawtooth-shaped region.

7. A tool device according to claim 7, wherein the piston rod is actuable by an actuating part engaging in the sawtooth-shaped region, the actuating part having a projection shaped to engage the sawtooth-shaped region.

8. A tool device according to claim 1, wherein the actuating part is acted upon by means of a thrust part, wherein a spring is provided between the actuating part and the thrust part and between a housing and the actuating part, respectively.

9. A tool device according to claim 7, wherein a stroke length H of a lubricating stroke corresponds to a tooth length of a sawtooth-shaped region of the piston rod.

10. A tool device according to claim 1, wherein the lubricant dispensing device is associated with a slide held in guides and movable by means of a spindle, wherein the spindle is rotated by means of a drive.

11. A tool device according to claim 9, wherein individual lubricating strokes can be triggered by a separate spindle movement by contact of a slide end face upon the thrust part.

12. A tool device according to claim 9, wherein the lubricant dispensing device has a separate slide bar for triggering individual lubricating strokes, the slide bar being retractable and extensible between the thrust part and the slide end wall.

13. A method for lubricating contra-sliding parts of a tool device having a drive for effecting the sliding operation or rolling operation, triggering a lubricating pulse by the following method steps:
(a) measuring of a path covered in an operating phase of the sliding parts;
(b) recording individual path lengths by means of a counter;
(c) comparing the total actual path length with a total path length after which a lubricating pulse is intended to be triggered; and
(d) triggering of a lubricating pulse by the drive for the sliding parts after the total actual path length equals the tool path length.

14. A tool device comprising a multi-axis machine.
